(19) United States
(12) Patent Application Publication
(10) Pub. No.: US 2025/0202699 A1
(43) Pub. Date: Jun. 19, 2025

(54) Modular Exponentiation Hardware Accelerator with Unconstrained Operands for Public Key Encryption

(71) Applicant: Intel Corporation, Santa Clare, CA (US)

(72) Inventors: Raghavan Kumar, Hillsboro, OR (US); Saurav Maji, Hillsboro, OR (US); Sachin Taneja, Hillsboro, OR (US); Sanu K. Mathew, Portland, OR (US)

(73) Assignee: Intel Corporation, Santa Clara, CA (US)

(21) Appl. No.: 18/545,718

(22) Filed: Dec. 19, 2023

(51) Int. Cl. H04L 9/30

(52) U.S. Cl. CPC H04L 9/3066

(57) ABSTRACT

Methods and apparatus relating to a modular exponentiation hardware accelerator with unconstrained operands for public key encryption are described. In an embodiment, a memory stores a base and a modulus. Logic circuitry left shifts the modulus one or more times until a most significant bit of the modulus reaches a threshold value. The base remains unchanged while the logic circuitry left shifts the modulus. Other embodiments are also disclosed and claimed.

### FIELD

The present disclosure generally relates to the field of hardware accelerators. More particularly, some embodiments relate to a modular exponentiation hardware accelerator with unconstrained operands for public key encryption.

### BACKGROUND

Generally, computing platforms include one or more processors and one or more accompanying circuits. The accompanying circuits may perform various functions to assist a processor in computing tasks that are to be performed.

For example, some implementations may include an accompanying circuit with an engine to accelerate cryptographic operations. However, some designs may severely restrict the range of input operands, which in turn limits usability of an accelerator engine for a wide range of applications.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram for scaling a modulus, according to an embodiment.

FIG. 2 illustrates a flow diagram for computing a Montgomery residue using a difference-of-bits method.

FIG. 3 illustrates a flow diagram for performing a Montgomery conversion using a scaled-modulus technique, according to an embodiment.

FIG. 4 illustrates a block diagram of a hardware datapath for a scaled-modulus technique, according to an embodiment.

FIG. 5 illustrates an example computing system.

FIG. 6 illustrates a block diagram of an example processor and/or System on a Chip (SoC) that may have one or more cores and an integrated memory controller.

FIG. 7(A) is a block diagram illustrating both an example in-order pipeline and an example register renaming, out-of-order issue/execution pipeline according to examples.

FIG. 7(B) is a block diagram illustrating both an example in-order architecture core and an example register renaming, out-of-order issue/execution architecture core to be included in a processor according to examples.

FIG. 8 illustrates examples of execution unit(s) circuitry.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, some designs may severely restrict the range of input operands, which in turn limits usability of an accelerator engine for a wide range of applications. For example, some accompanying circuits of a processor may include a security hardware module to accelerate cryptographic workloads such as Advanced Encryption Standard (AES), Rivest, Shamir, & Adleman or “RSA” (public key encryption technology), Elliptic Curve Cryptography (ECC), and/or hashing. For example, a Modular Exponentiation Unit (MEU) in the security hardware module may accelerate critical public-key functions like RSA-4K/2K/1K/512 signing and verification. Some current designs severely restrict the range of input operands (base and modulus), which in turn limit usability of this accelerator hardware for a wide range of applications. Such restrictions require users to restrict moduli (M) to values with most-significant-bit MSB=1. This means that RSA-4K may only use moduli>2⁴⁰⁹⁵, in turn, implying that the base (A) operand is restricted to values below M.

To this end, some embodiments provide a modular exponentiation hardware accelerator with unconstrained operands for public key encryption. In at least one embodiment, all constraints on base (A), exponent (e), and modulus (M) during modular exponentiation operations (A^{e} mod M) are removed when compared to some conventional solutions. Such an exponentiation hardware accelerator may be implemented as logic within a processor or an accompanying circuit, or chipset.

One consequence of eliminating the constraints on modulus (M) and base (A) is to ensure that A<M relationship is maintained. For example, prior solutions for ensuring maintenance of this relationship may include repeated subtraction or difference-of-bits methods, where the magnitude of the base A is corrected to ensure that it does not exceed the modulus M. For example, A^{e} mod M is only calculated when A<M, and if A is not less than M, A is set to A minus M to ensure the A<M relationship. Hence, repeated subtraction continuously subtracts the modulus (M) from the base (A) until the magnitude of A falls within [0, M]. While this technique is straightforward and relatively easy to implement (e.g., in firmware), it incurs exponential latency (e.g., worst-case latency of 2⁴⁰⁹⁶ cycles). Furthermore, the latency of this operation depends on the value of ‘A’ and therefore it can produce a timing side-channel leakage.

Generally, in a difference-of-bits method, the modulus M is left-shifted until it exceeds the value of A. Hence, if the MSB of A and M are at bit positions ‘x’ and ‘y’ respectively, then M is left-shifted x-y times. Thereafter, the modulus (M) is conditionally subtracted from the base (A) x-y times, while M is right-shifted back to its original value. At the end of these operations, the base (A) is guaranteed to be less than M. As a result, this operation involves repeated comparisons between A and M and incurs significant latency overheads for the two 4096 bit left-shifts required to align A and M. Furthermore, this operation may also leak timing side-channels due to the dependence of the loop count on the value of A.

By contrast, an embodiment provides a scaled modulus approach for unconstrained moduli support, where the modulus M is continuously left-shifted until its MSB equals 1. The base operand (A) remains unchanged. Thereafter, the modulus (M) is conditionally subtracted from the base (A), while M is right-shifted back to its original value. The left-shift operation is linear in complexity and enables a negligible area and latency overhead (e.g., less than 0.5%) for large word-size operands. Compared to difference-of-bits method, the proposed scheme may allow for a three-fold reduction in latency overhead.

Generally, the Programmer's Reference Manual for the security hardware module may specify that the modulus (M) and base (A) for a modular exponentiation (A^{e} mod M) are constrained as follows:
MSB of the modulus should be =1
RSA-4K, M≥2⁴⁰⁹⁵
RSA-2K, M≥2²⁰⁴⁷
RSA-1K, M≥2¹⁰²³
RSA-512, M≥2⁵¹¹
Base operand (A) should also be guaranteed to be less than the modulus (M).

By contrast, in at least one embodiment, a user may provide any desired value for M and A using the scaled modulus approach for unconstrained moduli support mentioned herein.

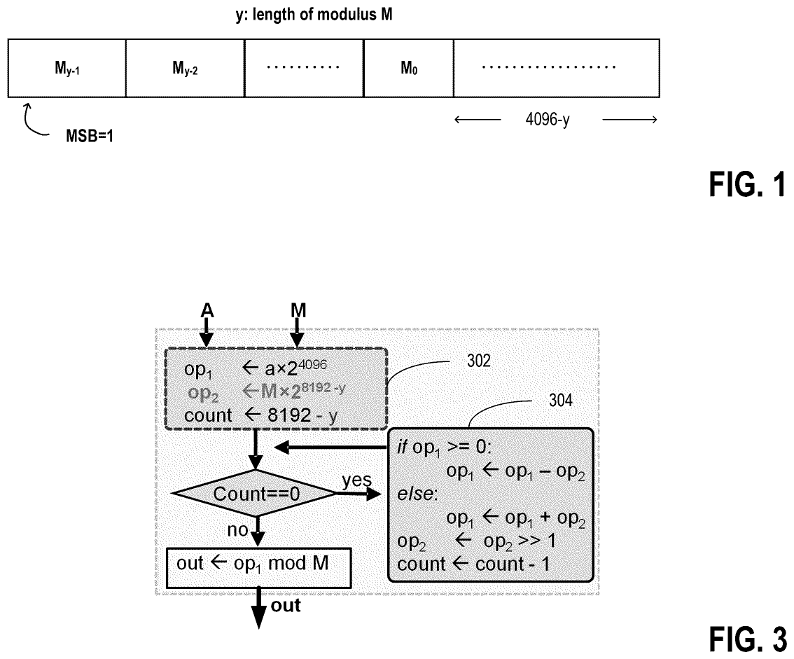

FIG. 1 illustrates a block diagram for scaling a modulus to have its most-significant bit reach 1, according to an embodiment. Moreover, some embodiments provide an unconstrained input operand support for an encryption accelerator hardware using the scaled modulus approach. In the example of FIG. 1, the moduli operand is repeatedly or continuously left-shifted by 4096-y bits until the moduli operand's most-significant bit reaches 1, while leaving the base untouched (see, e.g., FIG. 1). Scaling the modulus does not impact the result of the modular arithmetic operation due to the fundamental property of modular arithmetic.

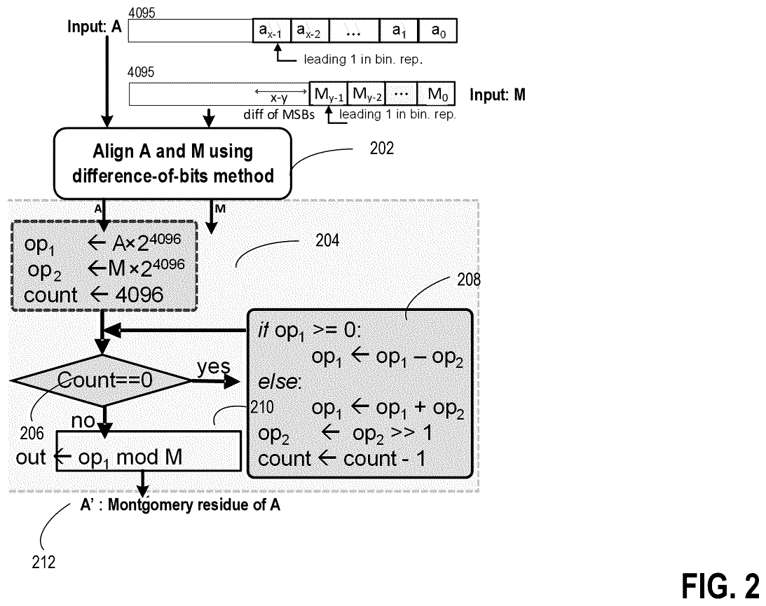

FIG. 2 illustrates a flow diagram for computing a Montgomery residue of ‘A’ using a difference-of-bits method. Generally, in modular arithmetic computation, Montgomery modular multiplication, also referred to as “Montgomery multiplication,” is a method for performing fast modular multiplication. It was introduced in 1985 by the American mathematician Peter L. Montgomery.

More particularly, the operation that is impacted by modulus scaling is the Montgomery conversion of base A (see, e.g., FIG. 2). Montgomery conversion of any 4K bit operand ‘x’ is calculated as x*2⁴⁰⁹⁶ mod M. In the conventional difference-of-bits method shown in FIG. 2, the operand A is first aligned to the modulus M using the difference-of-bits method (202) described earlier. The aligned operands A and M are then converted to the Montgomery domain (204) by left-shifting by 4096 bits, followed by a repeated (206) subtraction of the scaled modulus (208). After 4096 iterations (206), the base A will be contained within the modulus range M (210), producing in the Montgomery residue of A or A′ (212).

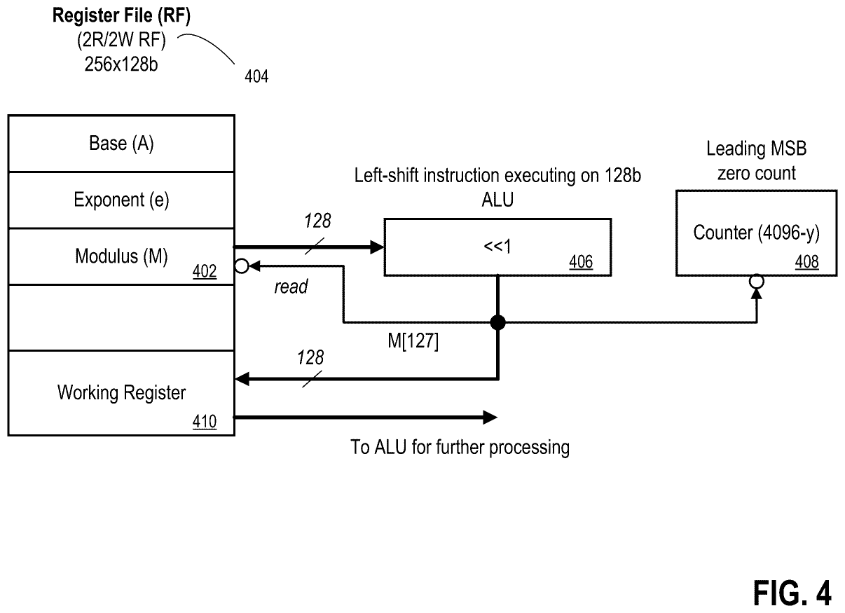

FIG. 3 illustrates a flow diagram for performing a Montgomery conversion of base A using a scaled-modulus technique, according to an embodiment. As shown in FIG. 3, the proposed scaled-moduli technique bypasses the need to explicitly align A and M (i.e., bypassing operation 202 of FIG. 2). Instead, the modulus M is left-shifted by 4096-y bits as described earlier to ensure that its MSB reaches 1 (304). The Montgomery residue of A is then computed with a loop count of 8192-y (to account for an additional 4096b left shift as required by Montgomery conversion, after the left shift by 4096-y to achieve the modulus MSB of ‘1’) (304), where y is the bit-width of M. For a fixed-size modulus, the proposed method also enables constant timing, thereby providing timing side-channel resistance.

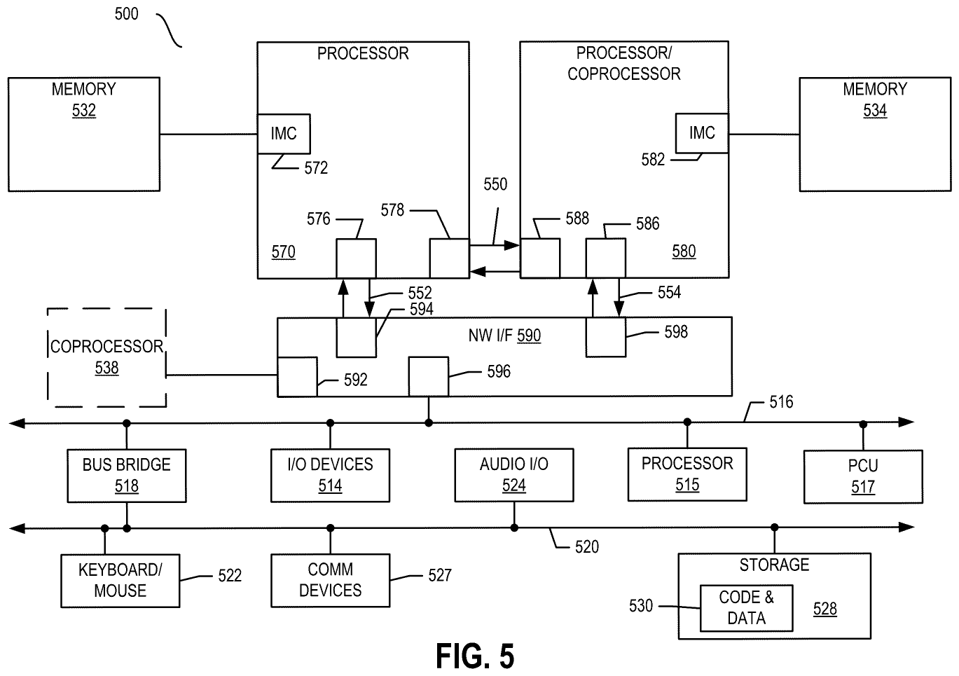

FIG. 4 illustrates a block diagram of a hardware datapath for a scaled-modulus technique, according to an embodiment. The modulus operand 402 read from a Register File (RF) memory 404 (which may be implemented as a macro in firmware or software) is continuously left-shifted by operating the 128b Arithmetic Logic Unit (ALU) 406 in a left-shift mode, e.g., through an instruction available in an instruction set architecture, until the hardware detects the most-significant bit (M [127]) to be 1. In FIG. 4, RF 404 is implemented as a 2R/2 W register file (which stands for 2 read and 2 write ported register file). The number of left-shifts is tracked in the leading MSB zero counter 408. Once the most-significant bit of ‘1’ is detected, the hardware gates the modulus operand read accesses and switches to perform Montgomery conversion, e.g., through an existing state machines and instruction set such as shown in FIG. 3. In one embodiment, a working or scratchpad register 410 may store the output of the shift operation and may further provide the stored data to the ALU for further processing, e.g., where the shifted modulus value is the one used inside the loop in FIG. 2 (for example “op2”) to effect the further processing.

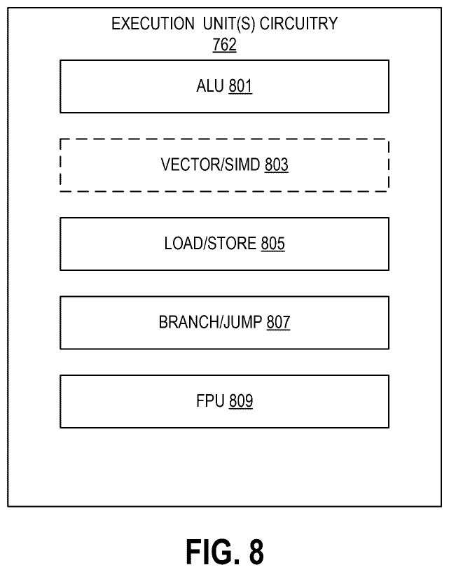

In an embodiment, the ALU utilized for operations discussed with reference to FIG. 4 is an (e.g., 128 bit) ALU provided in a corresponding exponentiation accelerator (or on a same semiconductor die, etc.), another ALU (e.g., provided in a separate accelerator), or an ALU in a processor such as the ALU 801 of FIG. 8.

A sample synthesis shows the scaled modulus approach may enable unconstrained input operands while imposing an area overhead of approximately less than 0.5% compared to the constrained design used in some conventional solutions (see, e.g., Table 1). Compared to the alternate difference-of-bits method, the scaled-modulus technique may offer three times lower latency overhead (e.g., 131K cycles vs. 393K cycles) for 4096-bit exponentiation. The 131K cycles latency overhead of the proposed design may represent less than approximately 0.6% increase over the 22M cycles latency incurred for modular exponentiation in some conventional designs.

TABLE 1
Performance Summary

| Encryption Accelerator | Unconstrained Inputs | Latency Overhead |
|---|---|---|
| Conventional Design | N | — |
| Difference-of-bits | Y | 393K |
| method | | |
| Scaled Modulus | Y | 131K |
| Embodiment | | |

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

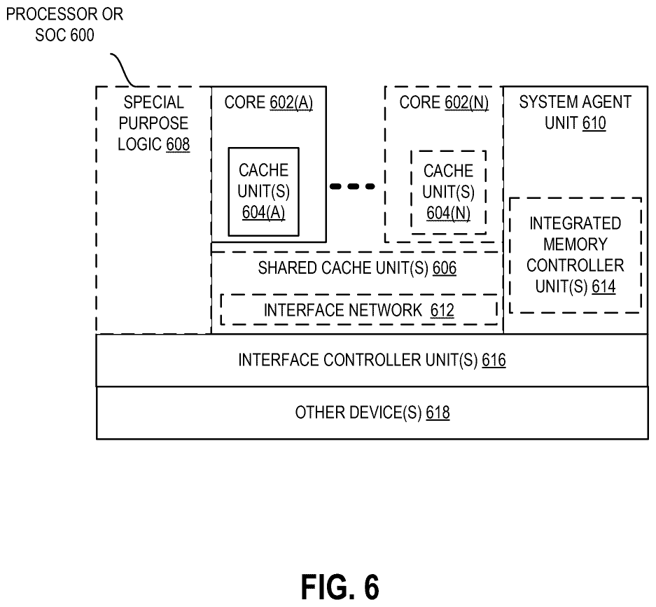

FIG. 5 illustrates an example computing system. Multiprocessor system 500 is an interfaced system and includes a plurality of processors or cores including a first processor 570 and a second processor 580 coupled via an interface 550 such as a point-to-point (P-P) interconnect, a fabric, and/or bus. In some examples, the first processor 570 and the second processor 580 are homogeneous. In some examples, first processor 570 and the second processor 580 are heterogenous. Though the example system 500 is shown to have two processors, the system may have three or more processors, or may be a single processor system. In some examples, the computing system is a system on a chip (SoC).

Processors 570 and 580 are shown including integrated memory controller (IMC) circuitry 572 and 582, respectively. Processor 570 also includes interface circuits 576 and 578; similarly, second processor 580 includes interface circuits 586 and 588. Processors 570, 580 may exchange information via the interface 550 using interface circuits 578, 588. IMCs 572 and 582 couple the processors 570, 580 to respective memories, namely a memory 532 and a memory 534, which may be portions of main memory locally attached to the respective processors.

Processors 570, 580 may each exchange information with a network interface (NW I/F) 590 via individual interfaces 552, 554 using interface circuits 576, 594, 586, 598. The network interface 590 (e.g., one or more of an interconnect, bus, and/or fabric, and in some examples is a chipset) may optionally exchange information with a coprocessor 538 via an interface circuit 592. In some examples, the coprocessor 538 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 570, 580 or outside of both processors, yet connected with the processors via an interface such as P-P interconnect, such that either or both processors' local cache information may be stored in the shared cache if a processor is placed into a low power mode.

Network interface 590 may be coupled to a first interface 516 via interface circuit 596. In some examples, first interface 516 may be an interface such as a Peripheral Component Interconnect (PCI) interconnect, a PCI Express interconnect or another I/O interconnect. In some examples, first interface 516 is coupled to a power control unit (PCU) 5 17, which may include circuitry, software, and/or firmware to perform power management operations with regard to the processors 570, 580 and/or co-processor 538. PCU 517 provides control information to a voltage regulator (not shown) to cause the voltage regulator to generate the appropriate regulated voltage. PCU 517 also provides control information to control the operating voltage generated. In various examples, PCU 517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 517 is illustrated as being present as logic separate from the processor 570 and/or processor 580. In other cases, PCU 517 may execute on a given one or more of cores (not shown) of processor 570 or 580. In some cases, PCU 517 may be implemented as a microcontroller (dedicated or general-purpose) or other control logic configured to execute its own dedicated power management code, sometimes referred to as P-code. In yet other examples, power management operations to be performed by PCU 517 may be implemented externally to a processor, such as by way of a separate power management integrated circuit (PMIC) or another component external to the processor. In yet other examples, power management operations to be performed by PCU 517 may be implemented within BIOS or other system software.

Various I/O devices 514 may be coupled to first interface 516, along with a bus bridge 518 which couples first interface 516 to a second interface 520. In some examples, one or more additional processor(s) 515, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 516. In some examples, second interface 520 may be a low pin count (LPC) interface. Various devices may be coupled to second interface 520 including, for example, a keyboard and/or mouse 522, communication devices 527 and storage circuitry 528. Storage circuitry 528 may be one or more non-transitory machine-readable storage media as described below, such as a disk drive or other mass storage device which may include instructions/code and data 530 and may implement the storage for one or more instructions in some examples. Further, an audio I/O 524 may be coupled to second interface 520. Note that other architectures than the point-to-point architecture described above are possible. For example, instead of the point-to-point architecture, a system such as multiprocessor system 500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

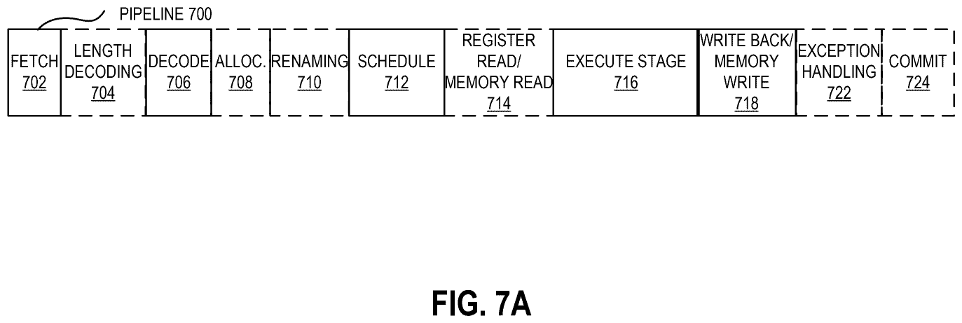

FIG. 6 illustrates a block diagram of an example processor and/or SoC 600 that may have one or more cores and an integrated memory controller. The solid lined boxes illustrate a processor 600 with a single core 602(A), system agent unit circuitry 610, and a set of one or more interface controller unit(s) circuitry 616, while the optional addition of the dashed lined boxes illustrates an alternative processor 600 with multiple cores 602(A)-(N), a set of one or more integrated memory controller unit(s) circuitry 614 in the system agent unit circuitry 610, and special purpose logic 608, as well as a set of one or more interface controller units circuitry 616. Note that the processor 600 may be one of the processors 570 or 580, or co-processor 538 or 515 of FIG. 5.

Thus, different implementations of the processor 600 may include: 1) a CPU with the special purpose logic 608 being integrated graphics and/or scientific (throughput) logic (which may include one or more cores, not shown), and the cores 602(A)-(N) being one or more general purpose cores (e.g., general purpose in-order cores, general purpose out-of-order cores, or a combination of the two); 2) a coprocessor with the cores 602(A)-(N) being a large number of special purpose cores intended primarily for graphics and/or scientific (throughput); and 3) a coprocessor with the cores 602(A)-(N) being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 604(A)-(N) within the cores 602(A)-(N), a set of one or more shared cache unit(s) circuitry 606, and external memory (not shown) coupled to the set of integrated memory controller unit(s) circuitry 614. The set of one or more shared cache unit(s) circuitry 606 may include one or more mid-level caches, such as level 2 (L2), level 3 (L3), level 4 (L4), or other levels of cache, such as a last level cache (LLC), and/or combinations thereof. While in some examples interface network circuitry 612 (e.g., a ring interconnect) interfaces the special purpose logic 608 (e.g., integrated graphics logic), the set of shared cache unit(s) circuitry 606, and the system agent unit circuitry 610, alternative examples use any number of well-known techniques for interfacing such units. In some examples, coherency is maintained between one or more of the shared cache unit(s) circuitry 606 and cores 602(A)-(N). In some examples, interface controller units circuitry 616 couple the cores 602 to one or more other devices 618 such as one or more I/O devices, storage, one or more communication devices (e.g., wireless networking, wired networking, etc.), etc.

In some examples, one or more of the cores 602(A)-(N) are capable of multi-threading. The system agent unit circuitry 610 includes those components coordinating and operating cores 602(A)-(N). The system agent unit circuitry 610 may include, for example, power control unit (PCU) circuitry and/or display unit circuitry (not shown). The PCU may be or may include logic and components needed for regulating the power state of the cores 602(A)-(N) and/or the special purpose logic 608 (e.g., integrated graphics logic). The display unit circuitry is for driving one or more externally connected displays.

The cores 602(A)-(N) may be homogenous in terms of instruction set architecture (ISA). Alternatively, the cores 602(A)-(N) may be heterogeneous in terms of ISA; that is, a subset of the cores 602(A)-(N) may be capable of executing an ISA, while other cores may be capable of executing only a subset of that ISA or another ISA.

### Example Core Architectures—In-Order and Out-of-Order Core Block Diagram

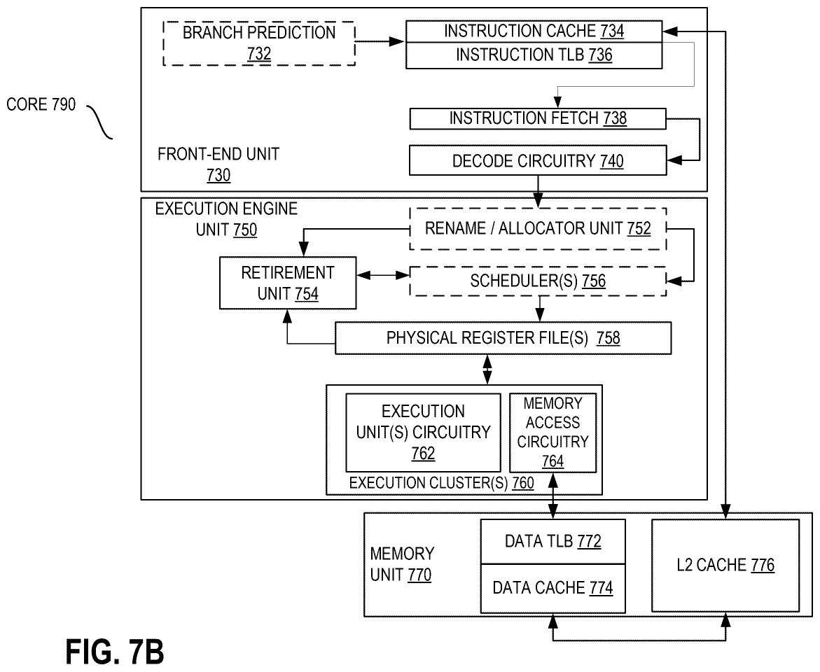

FIG. 7(A) is a block diagram illustrating both an example in-order pipeline and an example register renaming, out-of-order issue/execution pipeline according to examples. FIG. 7(B) is a block diagram illustrating both an example in-order architecture core and an example register renaming, out-of-order issue/execution architecture core to be included in a processor according to examples. The solid lined boxes in FIGS. 7(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7(A), a processor pipeline 700 includes a fetch stage 702, an optional length decoding stage 704, a decode stage 706, an optional allocation (Alloc) stage 708, an optional renaming stage 710, a schedule (also known as a dispatch or issue) stage 712, an optional register read/memory read stage 714, an execute stage 716, a write back/memory write stage 718, an optional exception handling stage 722, and an optional commit stage 724. One or more operations can be performed in each of these processor pipeline stages. For example, during the fetch stage 702, one or more instructions are fetched from instruction memory, and during the decode stage 706, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 706 and the register read/memory read stage 714 may be combined into one pipeline stage. In one example, during the execute stage 716, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 7(B) may implement the pipeline 700 as follows: 1) the instruction fetch circuitry 738 performs the fetch and length decoding stages 702 and 704; 2) the decode circuitry 740 performs the decode stage 706; 3) the rename/allocator unit circuitry 752 performs the allocation stage 708 and renaming stage 710; 4) the scheduler(s) circuitry 756 performs the schedule stage 712; 5) the physical register file(s) circuitry 758 and the memory unit circuitry 770 perform the register read/memory read stage 714; the execution cluster(s) 760 perform the execute stage 716; 6) the memory unit circuitry 770 and the physical register file(s) circuitry 758 perform the write back/memory write stage 718; 7) various circuitry may be involved in the exception handling stage 722; and 8) the retirement unit circuitry 754 and the physical register file(s) circuitry 758 perform the commit stage 724.

FIG. 7(B) shows a processor core 790 including front-end unit circuitry 730 coupled to execution engine unit circuitry 750, and both are coupled to memory unit circuitry 770. The core 790 may be a reduced instruction set architecture computing (RISC) core, a complex instruction set architecture computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit circuitry 730 may include branch prediction circuitry 732 coupled to instruction cache circuitry 734, which is coupled to an instruction translation lookaside buffer (TLB) 736, which is coupled to instruction fetch circuitry 738, which is coupled to decode circuitry 740. In one example, the instruction cache circuitry 734 is included in the memory unit circuitry 770 rather than the front-end circuitry 730. The decode circuitry 740 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 740 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 740 may be implemented using various different mechanisms. Examples of suitable mechanisms include, but are not limited to, look-up tables, hardware implementations, programmable logic arrays (PLAs), microcode read only memories (ROMs), etc. In one example, the core 790 includes a microcode ROM (not shown) or other medium that stores microcode for certain macroinstructions (e.g., in decode circuitry 740 or otherwise within the front-end circuitry 730). In one example, the decode circuitry 740 includes a micro-operation (micro-op) or operation cache (not shown) to hold/cache decoded operations, micro-tags, or micro-operations generated during the decode or other stages of the processor pipeline 700. The decode circuitry 740 may be coupled to rename/allocator unit circuitry 752 in the execution engine circuitry 750.

The execution engine circuitry 750 includes the rename/allocator unit circuitry 752 coupled to retirement unit circuitry 754 and a set of one or more scheduler(s) circuitry 756. The scheduler(s) circuitry 756 represents any number of different schedulers, including reservations stations, central instruction window, etc. In some examples, the scheduler(s) circuitry 756 can include arithmetic logic unit (ALU) scheduler/scheduling circuitry, ALU queues, address generation unit (AGU) scheduler/scheduling circuitry, AGU queues, etc. The scheduler(s) circuitry 756 is coupled to the physical register file(s) circuitry 758. Each of the physical register file(s) circuitry 758 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 758 includes vector registers unit circuitry, writemask registers unit circuitry, and scalar register unit circuitry. These register units may provide architectural vector registers, vector mask registers, general-purpose registers, etc. The physical register file(s) circuitry 758 is coupled to the retirement unit circuitry 754 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 754 and the physical register file(s) circuitry 758 are coupled to the execution cluster(s) 760. The execution cluster(s) 760 includes a set of one or more execution unit(s) circuitry 762 and a set of one or more memory access circuitry 764. The execution unit(s) circuitry 762 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 756, physical register file(s) circuitry 758, and execution cluster(s) 760 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 764). It should also be understood that where separate pipelines are used, one or more of these pipelines may be out-of-order issue/execution and the rest in-order.

In some examples, the execution engine unit circuitry 750 may perform load store unit (LSU) address/data pipelining to an Advanced Microcontroller Bus (AMB) interface (not shown), and address phase and writeback, data phase load, store, and branches.

The set of memory access circuitry 764 is coupled to the memory unit circuitry 770, which includes data TLB circuitry 772 coupled to data cache circuitry 774 coupled to level 2 (L2) cache circuitry 776. In one example, the memory access circuitry 764 may include load unit circuitry, store address unit circuitry, and store data unit circuitry, each of which is coupled to the data TLB circuitry 772 in the memory unit circuitry 770. The instruction cache circuitry 734 is further coupled to the level 2 (L2) cache circuitry 776 in the memory unit circuitry 770. In one example, the instruction cache 734 and the data cache 774 are combined into a single instruction and data cache (not shown) in L2 cache circuitry 776, level 3 (L3) cache circuitry (not shown), and/or main memory. The L2 cache circuitry 776 is coupled to one or more other levels of cache and eventually to a main memory.

The core 790 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 790 includes logic to support a packed data instruction set architecture extension (e.g., AVX1, AVX2), thereby allowing the operations used by many multimedia applications to be performed using packed data.

### Example Execution Unit(s) Circuitry

FIG. 8 illustrates examples of execution unit(s) circuitry, such as execution unit(s) circuitry 762 of FIG. 6(B). As illustrated, execution unit(s) circuitry 662 may include one or more ALU circuits 801, optional vector/single instruction multiple data (SIMD) circuits 803, load/store circuits 805, branch/jump circuits 807, and/or Floating-point unit (FPU) circuits 809. ALU circuits 801 perform integer arithmetic and/or Boolean operations. Vector/SIMD circuits 803 perform vector/SIMD operations on packed data (such as SIMD/vector registers). Load/store circuits 805 execute load and store instructions to load data from memory into registers or store from registers to memory. Load/store circuits 805 may also generate addresses. Branch/jump circuits 807 cause a branch or jump to a memory address depending on the instruction. FPU circuits 809 perform floating-point arithmetic. The width of the execution unit(s) circuitry 762 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a memory to store a base and a modulus; and shift logic circuitry to left shift the modulus one or more times until a most significant bit of the modulus reaches a threshold value, wherein the base remains unchanged while the logic circuitry left shifts the modulus. Example 2 includes the apparatus of example 1, wherein the threshold value is 1. Example 3 includes the apparatus of example 1, wherein the memory is to additionally store an exponent. Example 4 includes the apparatus of example 1, wherein a hardware accelerator comprises the memory and the shift logic circuitry. Example 5 includes the apparatus of example 4, wherein the hardware accelerator is to accelerate execution of a cryptographic workload. Example 6 includes the apparatus of example 5, wherein the cryptographic workload includes at least one of an Advanced Encryption Standard (AES) workload, a Rivest, Shamir, & Adleman (RSA) workload, an Elliptic Curve Cryptography (ECC) workload, a hashing workload. Example 7 includes the apparatus of example 4, wherein a System on Chip comprises the hardware accelerator and a processor having one or more processor cores.

Example 8 includes the apparatus of example 1, wherein the memory comprises a register file to store the base and modulus. Example 9 includes the apparatus of example 8, wherein the register file is to include a scratchpad register to store the left shifted modulus. Example 10 includes the apparatus of example 1, wherein an arithmetic logic unit comprises the shift logic circuitry. Example 11 includes the apparatus of example 1, wherein a processor, having one or more processor cores, comprises the memory and the shift logic circuitry. Example 12 includes the apparatus of example 1, wherein a value of the base and a value of the modulus is unconstrained.

Example 13 includes one or more non-transitory computer-readable media comprising one or more instructions that when executed on a processor configure the processor to perform one or more operations to cause: a memory to store a base and a modulus; and shift logic circuitry to left shift the modulus one or more times until a most significant bit of the modulus reaches a threshold value, wherein the base remains unchanged while the shift logic circuitry left shifts the modulus. Example 14 includes the one or more non-transitory computer-readable media of example 13, wherein the threshold value is 1.

Example 15 includes the one or more non-transitory computer-readable media of example 13, further comprising one or more instructions that when executed on the processor configure the processor to perform one or more operations to cause the memory to additionally store an exponent. Example 16 includes the one or more non-transitory computer-readable media of example 13, wherein a hardware accelerator comprises the memory and the shift logic circuitry. Example 17 includes the one or more non-transitory computer-readable media of example 16, further comprising one or more instructions that when executed on the processor configure the processor to perform one or more operations to cause the hardware accelerator to accelerate execution of a cryptographic workload.

Example 18 includes the one or more non-transitory computer-readable media of example 17, wherein the cryptographic workload includes at least one of an Advanced Encryption Standard (AES) workload, a Rivest, Shamir, & Adleman (RSA) workload, an Elliptic curve cryptography (ECC) workload, a hashing workload. Example 19 includes the one or more non-transitory computer-readable media of example 13, wherein an arithmetic logic unit comprises the shift logic circuitry. Example 20 includes the one or more non-transitory computer-readable media of example 13, wherein the processor comprises the memory and the shift logic circuitry.

Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Further, while various embodiments described herein use the term System-on-a-Chip or System-on-Chip (“SoC” or “SOC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems, the various dies, tiles and/or chiplets can be physically and/or electrically coupled together by a package structure including, for example, various packaging substrates, interposers, active interposers, photonic interposers, interconnect bridges, and the like. The disaggregated collection of discrete dies, tiles, and/or chiplets can also be part of a System-on-Package (“SoP”).

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a memory to store a base and a modulus; and
shift logic circuitry to left shift the modulus one or more times until a most significant bit of the modulus reaches a threshold value,
wherein the base remains unchanged while the logic circuitry left shifts the modulus.

2. The apparatus of claim 1, wherein the threshold value is 1.

3. The apparatus of claim 1, wherein the memory is to additionally store an exponent.

4. The apparatus of claim 1, wherein a hardware accelerator comprises the memory and the shift logic circuitry.

5. The apparatus of claim 4, wherein the hardware accelerator is to accelerate execution of a cryptographic workload.

6. The apparatus of claim 5, wherein the cryptographic workload includes at least one of an Advanced Encryption Standard (AES) workload, a Rivest, Shamir, & Adleman (RSA) workload, an Elliptic Curve Cryptography (ECC) workload, a hashing workload.

7. The apparatus of claim 4, wherein a System on Chip comprises the hardware accelerator and a processor having one or more processor cores.

8. The apparatus of claim 1, wherein the memory comprises a register file to store the base and modulus.

9. The apparatus of claim 8, wherein the register file is to include a scratchpad register to store the left shifted modulus.

10. The apparatus of claim 1, wherein an arithmetic logic unit comprises the shift logic circuitry.

11. The apparatus of claim 1, wherein a processor, having one or more processor cores, comprises the memory and the shift logic circuitry.

12. The apparatus of claim 1, wherein a value of the base and a value of the modulus is unconstrained.

13. One or more non-transitory computer-readable media comprising one or more instructions that when executed on a processor configure the processor to perform one or more operations to cause:
a memory to store a base and a modulus; and
shift logic circuitry to left shift the modulus one or more times until a most significant bit of the modulus reaches a threshold value,
wherein the base remains unchanged while the shift logic circuitry left shifts the modulus.

14. The one or more non-transitory computer-readable media of claim 13, wherein the threshold value is 1.

15. The one or more non-transitory computer-readable media of claim 13, further comprising one or more instructions that when executed on the processor configure the processor to perform one or more operations to cause the memory to additionally store an exponent.

16. The one or more non-transitory computer-readable media of claim 13, wherein a hardware accelerator comprises the memory and the shift logic circuitry.

17. The one or more non-transitory computer-readable media of claim 16, further comprising one or more instructions that when executed on the processor configure the processor to perform one or more operations to cause the hardware accelerator to accelerate execution of a cryptographic workload.

18. The one or more non-transitory computer-readable media of claim 17, wherein the cryptographic workload includes at least one of an Advanced Encryption Standard (AES) workload, a Rivest, Shamir, & Adleman (RSA) workload, an Elliptic curve cryptography (ECC) workload, a hashing workload.

19. The one or more non-transitory computer-readable media of claim 13, wherein an arithmetic logic unit comprises the shift logic circuitry.

20. The one or more non-transitory computer-readable media of claim 13, wherein the processor comprises the memory and the shift logic circuitry.
